(19) United States
(12) Patent Application Publication
(10) Pub. No.: US 2008/0228588 A1
(43) Pub. Date: Sep. 18, 2008

(54) E-Commerce System for the Purchasing Intermediation Type and Operating System for the Shopping-Mall Applied Thereof

(75) Inventors: Jung Ki Mihn, Seoul (KR); Kang Min Lee, Seoul (KR)

Correspondence Address: LUCAS & MERCANTI, LLP, 475 PARK AVENUE SOUTH, 15TH FLOOR, NEW YORK, NY, 10016, US

(73) Assignee: UCCCOMMERCE CO., LTD, Seoul (KR)

(21) Appl. No.: 11/994,574

(22) PCT Filed: Jun. 28, 2006
(86) PCT No.: PCT/KR2006/002526

§ 371 Date: Jan. 16, 2008

(30) Foreign Application Priority Data
Jul. 6, 2005 (KR) 10-2005-0060640
Apr. 25, 2006 (KR) 10-2006-0037143

(51) Int. Cl. G06Q 30/00; G06Q 20/00

(52) U.S. Cl. 705/26; 705/35

(57) ABSTRACT

The present invention relates to an electronic commerce system of a group-driven purchase broker type and a shopping mail operating system, wherein buyers can jointly purchase merchandise at a price lower than a regular price through a purchase broker group who negotiates prices with sellers, and sellers can make more profits owing to the increase of sales amount since a buyer does not individually purchase merchandise, but a plurality of buyers collectively purchase merchandise through the purchase broker group even though the sellers sell merchandise at a reduced price lower than the regular price. The electronic commerce system of the present invention comprises a shopping mall operating company; a sales client; a group client connected to the shopping mall operating company; a purchase client; and a wired/wireless communication network for connecting the shopping mall operating company, the sales client, the group client and the purchase client with one another.

### TECHNICAL FIELD

The present invention relates to an electronic commerce system of a group-driven purchase broker type and a shopping mall operating system applied thereto, and more particularly, to an electronic commerce system of a group-driven purchase broker type and a shopping mall operating system applied thereto, wherein buyers can jointly purchase merchandise at a price lower than a regular price through a purchase broker group (alumni association, society, etc.) who negotiates prices with sellers, and sellers can make more profits owing to the increase of sales amount since a buyer does not individually purchase merchandise, but a plurality of buyers collectively purchase merchandise through the purchase broker group even though the sellers sell merchandise at a reduced price lower than the regular price.

### BACKGROUND ART

According to rapid spread of the Internet, on-line shopping malls where sellers and buyers dealing a variety of merchandise make transactions and payment for merchandise on-line without directly meeting each other have been recently generalized. In the initial stage of such on-line shopping malls, mall-in-mall type shopping malls (Interpark, Samsung Mall, Amazon, etc.) mostly driven by large enterprises on the foundation of high reputation were popular. However, a relevant shopping mall operating company should directly manage all sorts of solutions and infrastructures needed for sales, after services (delivery, refund/exchange, etc.), and the like. Accordingly, there is a problem in that merchandise can be distributed only when a certain amount of margin is expected, and it is difficult to distribute competitive merchandise since a specific seller is mostly designated as an exclusive provider of a specific item. However, open-market type shopping malls (hereinafter, referred to as ‘e-marketplace shopping malls’, such as Auction, G-Market, eBay, etc.) are much in vogue recently, wherein a shopping mall operating company only acts as a broker between sellers and buyers and manages general distribution solutions, such as advertisement, operation, settlement, or payment for merchandise, whereas the sellers by themselves register merchandise and manage after services associated with sales, so that the shopping mall operating company can be operated at a lower cost. Further, since a plurality of sellers competes with one another to sell merchandise of the same kind for each item, the price of the merchandise are lowered.

Meanwhile, off-line joint purchase, which is transacted generally between the affiliated companies of a large enterprise, is increased due to high efficiency. Here, the ‘joint purchase’ is a method in which a plurality of buyers who wish to purchase the same kind of merchandise designates a seller and purchases the merchandise by jointly ordering the merchandise. Most of the affiliated companies of a large enterprise jointly purchase merchandise together with partner companies to thereby build up huge buying power. Accordingly, all participants can purchase merchandise at a lower price. Therefore, it is advantageous in that through joint purchase, buyers can purchase merchandise at a price much lower than that of individual purchase by making best use of a variety of benefits such as product cost reduction, planned orders, and distribution cost reduction, whereas sellers can make more profits owing to the increase of sale amount.

However, according to the aforementioned joint purchase method, a high discount rate can be applied to large enterprises due to a large transaction scale even though they do not employ the aforementioned joint purchase method. Contrarily, since medium and small enterprises seldom do businesses through the joint purchase method and transaction amount is relatively smaller than that of a large enterprise, there is a problem in that a discount rate as much as a large enterprise cannot be applied to the medium and small enterprises.

Furthermore, when a plurality of individuals other than enterprises jointly purchases merchandise, purchase demands are much smaller and cannot be estimated. Thus, there is a problem in that individuals who desire to participate in the joint purchase are hard to negotiate a price at a more advantageous position than sellers and the discount rate is lower than that of an enterprise. Meanwhile, a specific on-line shopping mall has directly attempted to perform the collective purchase or joint purchase centering on a relevant shopping mall site. However, since the participants do neither have a common sense of belonging nor actively take part in purchase, it has not been widely employed so much.

Presently, on-line shopping mall operators or on-line sellers uniformly determine the price of merchandise and sell the merchandise without regard to buyers' buying power. Therefore, enterprises or individuals who wish to purchase specific merchandise in a large quantity frequently get in direct touch with sellers in order to separately receive an estimate and purchase merchandise.

Furthermore, since prices of most of merchandise are easily open to everybody through price comparison sites, on-line shopping mall operators or on-line sellers should make a great deal of efforts to establish price order in distribution channels, and thus, side effects such as frequent request for refund are sometimes produced. Particularly, since manufacturers or exclusive sellers are not free from open prices even when they wish to clear the remaining stock or need urgent money, dishonors amid profits frequently occur.

Still furthermore, most of on-line shopping mall operators or on-line sellers invest a great deal of advertising expenses through multimedia and develop direct marketing to attract enterprise or individual customers. However, they greatly suffer from unsatisfied effect on investment.

### DISCLOSURE

### Technical Problem

The present invention is conceived to solve the aforementioned problems in the prior art. An object of the present invention is to provide an electronic commerce system of a group-driven purchase broker type and a shopping mall operating system applied thereto, wherein buyers connecting to on-line shopping malls gather together centering on a specific group (alumni association, society, etc.) in which buyers are already gathered on-line or off-line, and the group functions as a center of efficient purchase brokerage, thereby providing a purchase brokerage environment.

Another object of the present invention is to provide an electronic commerce system of a group-driven purchase broker type and a shopping mall operating system applied thereto, wherein sellers do not offer the same price to a plurality of groups of buyers gathered centering on a group, but offer a further discounted price to a purchase group having big buying power by determining a different price based on the number of buyers belonging to the group or monthly purchase amount of the group and registering merchandise at the determined prices, thereby allowing a large purchase group to purchase merchandise at a lower price.

A further object of the present invention is to provide an electronic commerce system of a group-driven purchase broker type and a shopping mall operating system applied thereto, wherein a specific group in charge of purchase brokerage allows a buyer of a large purchase quantity to purchase merchandise at a further reduced price according to the purchase amount of the buyer belonging to the group and allows a general buyer of small purchase amount to purchase merchandise at a price lower than that of individual purchase through joint purchase even though the purchase amount is not large.

A still further object of the present invention is to provide an electronic commerce system of a group-driven purchase broker type and a shopping mall operating system applied thereto, wherein if on-line shopping mall operators or on-line sellers sell merchandise according to the on-line distribution method of the present invention, a different price is determined for each buyer belonging to the relevant group, and the price of one buyer is not known to the other buyers and even to price comparison sites, and thus, they can comfortably sell merchandise.

A still further object of the present invention is to provide an electronic commerce system of a group-driven purchase broker type and a shopping mall operating system applied thereto, wherein sellers of enterprise merchandise or personal merchandise do not need to invest a great deal of advertisement expenses in direct marketing to attract enterprise or individual customers, but can efficiently develop relation marketing through a plurality of large groups.

### Technical Solution

According to an aspect of the present invention for achieving the objects, there is provided an electronic commerce system of a group-driven purchase broker type, comprising a shopping mall operating company for providing an on-line shopping mall where a variety of merchandise is transacted and for storing discount rates of merchandise registered in the on-line shopping mall; a sales client for registering information including prices of a variety of merchandise in the shopping mall operating company; a group client connected to the shopping mall operating company to broker sales of merchandise at a price to which the discount rate is applied; a purchase client belonging to the group client and connected to the shopping mall operating company to purchase merchandise through brokerage of a purchase the group client at the price to which the discount rate is applied; and a wired/wireless communication network for connecting the shopping mall operating company, the sales client, the group client and the purchase client with one another.

According to another aspect of the present invention for achieving the objects, there is provided a shopping mall operating system, comprising a shopping mall server for providing on-line shopping mall services through a wired/wireless communication network; a member information DB for storing credit information of a sales client, a purchase client, and a group client for brokering transactions of merchandise between the sales client and the purchase client, each client being connected to the shopping mall server through the wired/wireless communication network; a merchandise information DB for storing information on a variety of merchandise registered in the shopping mall server by the sales client; a discount information DB for storing discount rates to be applied to the merchandise registered by the sales client; and a management server for sending the discount rates stored in the discount information DB to the shopping mall server based on the credit information of the group client stored in the member information DB if the purchase client connected to the shopping mall server is a purchase client belonging to the group client.

According to a further aspect of the present invention for achieving the objects, there is provided an electronic commerce method of a group-driven purchase broker type which is performed between a shopping mall operating company for providing an on-line shopping mall where a variety of merchandise is transacted, a sales client for registering information on a variety of merchandise in the shopping mall operating company through a wired/wireless communication network, a purchase client for purchasing a variety of merchandise from the shopping mall operating company through the wired/wireless communication network, and a plurality of group clients connected to the shopping mall operating company through the wired/wireless communication network for brokering transactions of merchandise between the sales client and the purchase client. The method comprises the steps of (a) registering, by the sales client, information on merchandise in the shopping mall operating company; (b) providing, by the shopping mall operating company, credit information of a plurality of the group clients to the sales client; (c) selecting, by the sales client, a certain group client for brokering the merchandise registered in step (a); (d) selecting, by the purchase client, the merchandise registered in step (a); and (e) offering, by the shopping mall operating company, a price of merchandise, to which a predetermined discount rate is applied, to the purchase client based on the credit information of the group client selected in step (c), if the purchase client in step (d) is a purchase client belonging to the group client selected in step (c).

According to a still further aspect of the present invention for achieving the objects, there is provided a shopping mall operating method which is performed by a shopping mall operating company between the shopping mall operating company for providing an on-line shopping mall where a variety of merchandise is transacted, a sales client for registering information on a variety of merchandise in the shopping mall operating company through a wired/wireless communication network, a purchase client for purchasing a variety of merchandise from the shopping mall operating company through the wired/wireless communication network, and a plurality of group clients connected to the shopping mall operating company through the wired/wireless communication network for brokering transactions of merchandise between the sales client and the purchase client. The method of the present invention comprises the steps of (a) storing information on certain merchandise registered by the sale client; (b) providing credit information of a plurality of the group clients to the sale client; (c) selecting, by the sales client, a certain group client for brokering the merchandise registered in step (a); (d) applying a predetermined discount rate to the registered merchandise based on the credit information of the group client selected in step (c); and (e) offering a price of the merchandise to which the discount rate in step (d) is applied, if a purchase client belonging to the group client selected in step (c) requests to purchase merchandise.

### DESCRIPTION OF DRAWINGS

FIG. 1 shows a network configuration of an electronic commerce system of a group-driven purchase broker type according to an embodiment of the present invention.

FIG. 2 shows a system configuration of a shopping mall operating company shown in FIG. 1.

FIG. 3 is a flowchart illustrating a process of applying for joining a specific group, by a buyer, in an electronic commerce method of a group-driven purchase broker type according to an embodiment of the present invention.

FIG. 4 is a flowchart illustrating a process of determining a discount level of a purchase broker group based on a transaction scale in a shopping mall operating method according to an embodiment of the present invention.

FIG. 5 is a flowchart illustrating a process of discriminatingly determining, by a purchase broker group, a discount level of a buyer belonging to the group based on purchase amount of the buyer in an electronic commerce method of a group-driven purchase broker type according to an embodiment of the present invention.

FIG. 6 is a flowchart illustrating a process of registering merchandise of a seller in an electronic commerce method of a group-driven purchase broker type according to an embodiment of the present invention.

FIGS. 7 to 9 are exemplary views illustrating a process of determining a discount rate by a seller in an electronic commerce method of a group-driven purchase broker type according to an embodiment of the present invention.

FIG. 10 is a flowchart illustrating a process of purchasing merchandise by a buyer in an electronic commerce method of a group-driven purchase broker type according to an embodiment of the present invention.

FIG. 11 is a view illustrating an example of prices discriminatingly applied by a seller based on a group size according to an embodiment of the present invention.

### BEST MODE

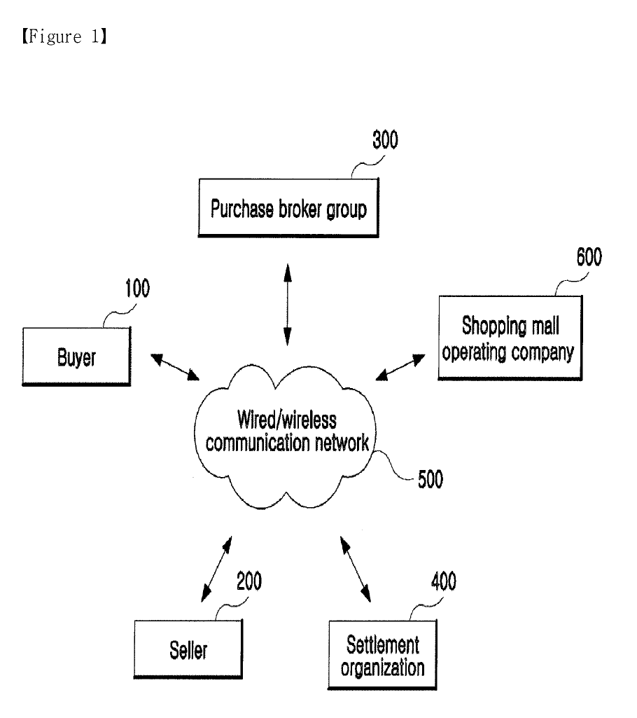

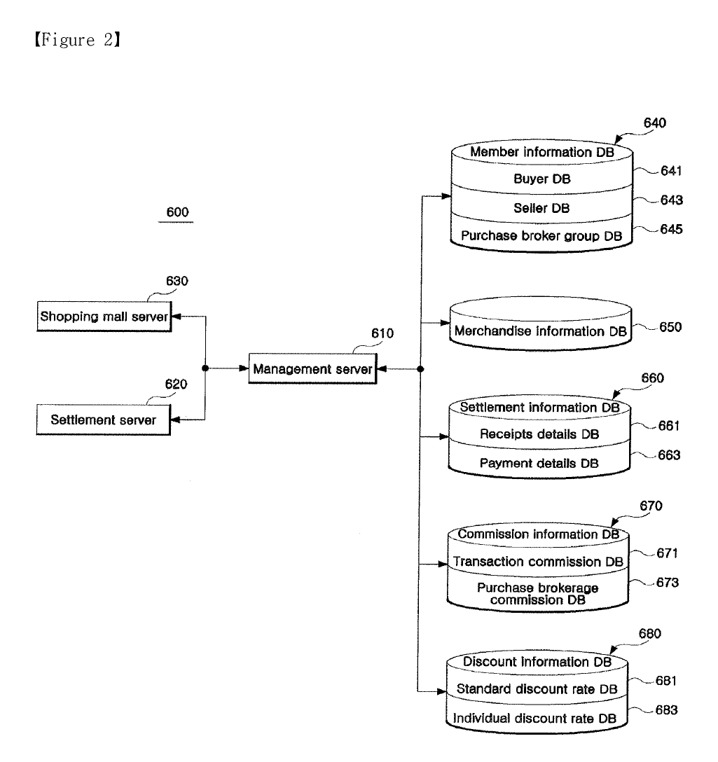

Hereinafter, an electronic commerce system of a group-driven purchase broker type and a shopping mall operating system applied thereto according to a preferred embodiment of the present invention will be described in detail with reference to FIGS. 1 and 2.

First, FIG. 1 shows a network configuration of an electronic commerce system of a group-driven purchase broker type according to an embodiment of the present invention.

As shown in FIG. 1, the network configuration of an electronic commerce system of a group-driven purchase broker type according to the present invention comprises a shopping mall operating company 600 for providing an e-marketplace type shopping mall, i.e. an on-line brokerage marketplace, where a variety of merchandise is transacted; a sales client (hereinafter, referred to as a seller) 200 for registering information on a variety of merchandise in the shopping mall operating company 600; a purchase client (hereinafter, referred to as a buyer) 100 for purchasing a variety of merchandise through the shopping mall operating company 600; a purchase broker group client (hereinafter, referred to as a purchase broker group) 300 for offering a price discounted from a regular price under the agreement with the seller 200 based on the policies of the shopping mall operating company 600; a settlement organization 400 for making a variety of payment arising from transactions of merchandise between the buyer 100, seller 200, purchase broker group (hereinafter, also referred to as a group) 300 and shopping mall operating company 600; and a wired/wireless communication network 500 for connecting the buyer 100, seller 200, purchase broker group 300, and settlement organization 400 to the shopping mall operating company 600.

In the aforementioned descriptions, the buyer 100 and the seller 200 can be an individual or an enterprise without regard to transaction scales. The purchase broker group 300 can be a variety of groups where certain buyers 100 pursuing the same object have joined as members through the shopping mall operating company 600, such as the Korean Textile Industry Association, Korean Venture Business Association, S University Alumni Association, K High School Alumni Association, Korean Textile Workers' Union, Rotary Korea, Social Welfare Community Chest, Y University Student Association, HY Church, on-line clubs, specific membership groups organized and operated by a plurality of members (for example, a member group of credit card companies, a member group of mobile communication companies, or a policyholder group), or the like.

In addition, the buyer 100, the seller 200 and the purchase broker group 300 connect to the shopping mall operating company 600 through a communication terminal such as a computer or mobile communication terminal, wherein the computer is a notebook or desktop computer mounted with a web browser and the mobile communication terminal is a portable and mobile wireless communication device mounted with a wireless application protocol (WAP) browser (hereinafter, both of the web and WAP browsers are referred to as a browser), which is any kind of handheld-based wireless communication device such as a personal communication system (PCS), global system for mobile communications (GSM), personal digital cellular (PDC), personal handyphone system (PHS), personal digital assistant (PDA), international mobile telecommunication (IMT)-2000 terminal, digital multimedia broadcasting (DMB) phone, smart phone or the like.

Next, the settlement organization 400 can includes any kinds of settlement organization, such as a credit card company, bank and mobile communication service company, which can pay and bill according to transactions of merchandise.

The wired/wireless communication network 500 can be any kind of a wired communication network such as a local area network (LAN), wide area network (WAN) or value added network (VAN), or any kind of a wireless communication network such a mobile radio communication network, wireless Internet network or satellite communication network. Particularly, a connection between the settlement organization 400 and the shopping mall operating company 600 is preferably implemented in a value added communication network.

Further, FIG. 2 shows a system configuration of the shopping mall operating company shown in FIG. 1. As shown in FIG. 2, the shopping mall operating company 600 according to the present invention is configured as a web server, which comprises a shopping mall server 630 for providing all sorts of solutions and applications related to an on-line shopping mall, such as hyper texts, computer graphics and the like; a settlement server 620 connected to the settlement organization 400 to input and output data related to payment for merchandise; a member information database (DB) 640 for storing credit information of members of the shopping mall operating company 600, i.e. sellers, buyers, and purchase broker groups; a merchandise information DB 650 for storing information on a variety of merchandise registered by the sellers 200 through the shopping mall server 630; a settlement information DB 660 for storing settlement descriptions according to transactions of merchandise with members; a commission information DB 670 for storing commission information needed to determine commissions for accomplished transactions; a discount information DB 680 for storing discount rate information to be applied to the prices of a variety of merchandise stored in the merchandise information DB 650; and a management server 610 for managing the respective servers and DBs as a whole.

In the aforementioned configuration, the member information DB 640 comprises a buyer DB 641 for storing credit information of buyers of the shopping mall operating company 600, a seller DB 643 for storing credit information of sellers, and a purchase broker group DB 645 for storing credit information of purchase broker groups.

The buyer DB 641 stores, by each buyer, buyer's identification and relevant password that are needed when the buyer connects to the shopping mall server 630, and the other credit information. Here, if the buyer is an individual, a national resident number, name, address, occupation, e-mail address, sex, bank account number, amount and number of transactions with the shopping mall operating company 600, and the like can be stored as the other credit information. If the buyer is an enterprise, a business registry number, enterprise's name, business area, sales amount, number of employees, e-mail address, bank account number, amount and number of transactions with the shopping mall operating company 600, and the like can be stored as the other credit information. In the same manner, the items of the credit information of the seller stored in the seller DB 643 is hardly different from the items stored in the buyer DB 641.

The purchase broker group DB 645 stores, by each group, basic credit information, such as group identification and relevant password, group name, address, e-mail address, bank account number and the like. Particularly, the purchase broker group DB 645 stores credit information related to purchase brokerage, such as credit information of a buyer belonging to a relevant group and a buyer discount level based on the credit (hereinafter, referred to as a ‘buyer grade’), a transaction scale index of a relevant group and a group discount level based on the index (hereinafter, referred to as a ‘group grade’), information on merchandise registered under the agreement with the seller (for example, a name and regular price of merchandise), and registration requirements of a non-member buyer.

Here, the transaction scale index is an index indicating buying power of a purchase broker group, including an annual transaction amount, the number of transactions, total buying power of buyers belonging to the group (for example, a purchase amount in the case of an enterprise, and the number of transactions with the shopping mall operating company 600 in the case of an individual), and the like.

In addition, the buyer grade can be freely determined by a relevant group itself based on a degree of contribution of the buyer 100 to the group or a monthly purchase amount of a variety of merchandise purchased through the purchase broker group 300, an example of which is shown in Table 1.

TABLE 1

| Monthly | Less than | Less than | Less than | Less than | Less than |
|---|---|---|---|---|---|
| purchase | 500,000 | 1,000,000 | 2,000,000 | 3,000,000 | 5,000,000 |
| amount | Won | Won | Won | Won | Won |
| Buyer grade | Grade 5 | Grade 4 | Grade 3 | Grade 2 | Grade 1 |

In addition, the aforementioned group grade can be determined based on the total amount obtained by summing up the monthly purchase amount of all buyers belonging to the group, an example of which is shown in Table 2.

TABLE 2

| Monthly | Less than | Less than | Less than | Less than | 1,000,000,000 |
|---|---|---|---|---|---|
| purchase | 100,000,000 | 200,000,000 | 500,000,000 | 1,000,000,000 | Won |
| amount | Won | Won | Won | Won | or more |
| Group grade | Grade 5 | Grade 4 | Grade 3 | Grade 2 | Grade 1 |

Next, merchandise information stored in the merchandise information DB 650 can be largely classified in order of the merchandise type and the seller who have registered the merchandise. The merchandise information classified as such includes a merchandise image, merchandise name, market price, remaining quantity, shipping fees, and the like. Particularly, a purchase price for a non-member buyer and a factory price for each group grade are stored in the merchandise information DB.

Here, types of merchandise stored in the merchandise information DB 650 are exemplified in Table 3.

TABLE 3

| Classification | Item | Detailed descriptions |
|---|---|---|
| Enterprise | Office supplies | Stationery, office machines, |
| merchandise | | Office appliances, etc. |
| | Computers/Appliances | Printers, Computer |
| | | expendables, Lamps, Cables, |
| | | etc. |
| | Tools/Welding/ | Working tools, Hand tools, |
| | Machinery | Cutting/grinding tools, |
| | | Measuring tools, etc. |
| | Industrial supplies | Lubricants, Packing |
| | | materials, etc |
| | Services | Quick services, Airline |
| | | tickets, Travel tickets, |
| | | etc. |
| | Gifts/Promotional | Gift certificates, |
| | gifts | Cosmetics, Memo papers, Key |
| | | holders, etc. |
| | Raw-subsidiary | Original textile, Petroleum, |
| | materials/Half | Steel, Panels, Flour, etc. |
| | finished products | |
| Individual | Daily products | Home appliances, Digital |
| merchandise | | appliances, Fitness |
| | | supplies, Clothing, etc. |

Next, the discount information DB 680 comprises a standard discount rate DB 681 for storing standard discount rates, such as the merchandise discount rates shown in Table 4, previously determined by the shopping mall operating company 600 based on the group grade of each group and the buyer grade stored in the purchase broker group DB 645; and an individual discount rate DB 683 for storing information on merchandise discount rates directly registered by the seller 200.

TABLE 4

| | 1^{st} grade | 2^{nd} grade | 3^{rd} grade | 4^{th} grade | 5^{th} grade |
|---|---|---|---|---|---|
| | buyer | buyer | buyer | buyer | buyer |
| 1^{st} grade | 20% | 19% | 18% | 17% | 16% |
| group | | | | | |
| 2^{nd} grade | 17% | 16% | 15.5% | 15% | 14% |
| group | | | | | |
| 3^{rd} grade | 15% | 14% | 13% | 12% | 11% |
| group | | | | | |
| 4^{th} grade | 12% | 11% | 10% | 9% | 8% |
| group | | | | | |
| 5^{th} grade | 8% | 7% | 6% | 5.5% | 5% |
| group | | | | | |

That is, if a specific buyer belongs to the 3^{rd} grade group and is a 2^{nd} grade buyer within the group based on the examples illustrated in Tables 1 to 3, the buyer can purchase merchandise at a price discounted by 14% from a regular price. If the buyer acquires a higher grade and belongs to a large group of first grade rather than a small group of 5^{th} grade, the buyer can receive benefits of a higher discount.

The commission information DB 670 comprises a transaction commission DB 671 for storing information on transaction commissions that the shopping mall operating company 600 receives when the transactions are accomplished between the buyer 100 and seller 200, and a purchase brokerage commission DB 673 for storing information on brokerage commissions that the purchase broker group 300 receives when the transactions are accomplished between the buyer 100 and seller 200.

The settlement information DB 660 comprises a receipts details DB 661 for storing details of payment made by the buyer 100 for certain merchandise purchase, which are notified from the settlement organization 400; and a payment details DB 663 for storing details of payment made to the seller 200 and the purchase broker group 300 respectively as a price of merchandise and a brokerage commission, which are notified from the settlement organization 400.

The shopping mall server 630 provides a community, i.e. an Internet cafe, by the group, and the community can be divided into specific small groups by a university entrance year, region or business type. Accordingly, a profit sharing structure of each small group is registered according to a purchase state of buyers belonging to the small group.

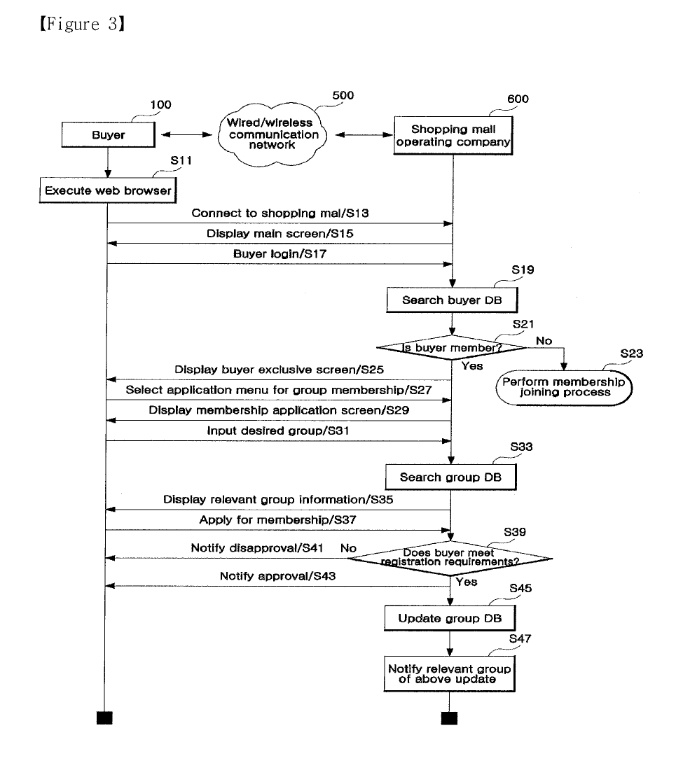

Hereinafter, a whole process of the electronic commerce method and the shopping mall operating method applied thereto according to the system of FIGS. 1 and 2 will be described in detail with reference to FIGS. 3 to 11.

FIG. 3 is a flowchart illustrating a process of applying for joining a specific group, by each buyer, in an electronic commerce method of a group-driven purchase broker type according to an embodiment of the present invention.

First, the buyer 100 executes a web browser or a WAP browser by driving a certain communication terminal in step S11 and connects to the shopping mall operating company 600 in step S13. Next, in step S15, the shopping mall server 630 displays a main screen on the communication terminal of the connected buyer 100. In step S17, the buyer 100 inputs buyer's identification and password into the login section dedicated to the buyer 100 on the main screen displayed through the browser. In step S19, the management server 610 searches the buyer DB 641 for data matching to the inputted data, i.e. the buyer's identification and password. In step S21, based on the searching results in step S19, the management server 610 determines whether the logged in buyer 100 is an existing member. If it is determined that the buyer is not a member, a process of joining membership is processed by the buyer 100 in step S23. As a step of joining membership performed by the shopping mall operating company 600, the shopping mall operating company first notifies terms and conditions such as the aforementioned brokerage commission and merchandise discount rate to the non-member buyer 100. If the buyer 100 agrees on the notified terms and conditions, the shopping mall operating company receives a variety of the aforementioned credit information and approves the buyer as a member.

On the other hand, if it is determined in step S21 that the buyer 100 is a member, the shopping mall server 630 displays a buyer exclusive screen in step S25. In step S27, the buyer 100 selects an application menu for group membership provided on the buyer exclusive screen. In step S29, the shopping mall server 630 displays an application screen for group membership on the communication terminal of the buyer 100.

The buyer 100 inputs a desired group in step S31, and the management server 610 searches the purchase broker group DB 645 in step S33. The shopping mall server 630 displays information on the relevant group on the communication terminal of the buyer 100 in step S35.

The buyer 100 applies for membership of a relevant group in step S37, and the application information of the buyer 100 is transferred to an administrator of the relevant group in step S39. The administrator of the relevant group determines whether the buyer meets the registration requirements. Registration of the buyer is determined based on predetermined judgment criteria, such as whether the buyer 100 has inputted a group code previously provided by the relevant group when the buyer applies for membership of the group, whether the buyer had already been registered as a member of the relevant group, whether the buyer had normally paid membership fees even if the buyer had been registered as a member, and whether the buyer has certain buying power. In addition, the management server 610 may be a subject of determination in step S39 and can determine automatically whether the buyer 100 applying for group membership meets the registration requirements based on the information on the ‘registration requirements of a non-member buyer’ stored in the purchase broker group DB 645.

If the buyer does not meet the registration requirements in step S39, the shopping mall operating company notifies disapproval to the buyer 100 in step S41. Alternatively, if the buyer meets the registration requirements in step S39, the shopping mall operating company notifies approval of joining the group to the buyer 100 in step S43 and updates the purchase broker group DB 645 in step S45, in which credit information of the buyer 100 approved to join the group is included as a matter of course, and a buyer grade is determined based on the degree of contribution of the buyer 100 to the group, information on expected purchase such as expected monthly purchase amount, and the like. The shopping mall operating company 600 notifies the fact (--> update of the purchase broker group DB) to the corresponding group in step S47 via an e-mail, a short message service (SMS) or the like. As time passes, the administrator of the group refers to buyer's credit, contribution, and expected purchase amount at every predetermined period. If the transaction amount of the buyer 100 is increased, the administrator upgrades the buyer grade so that the buyer can purchase merchandise at a further lower price.

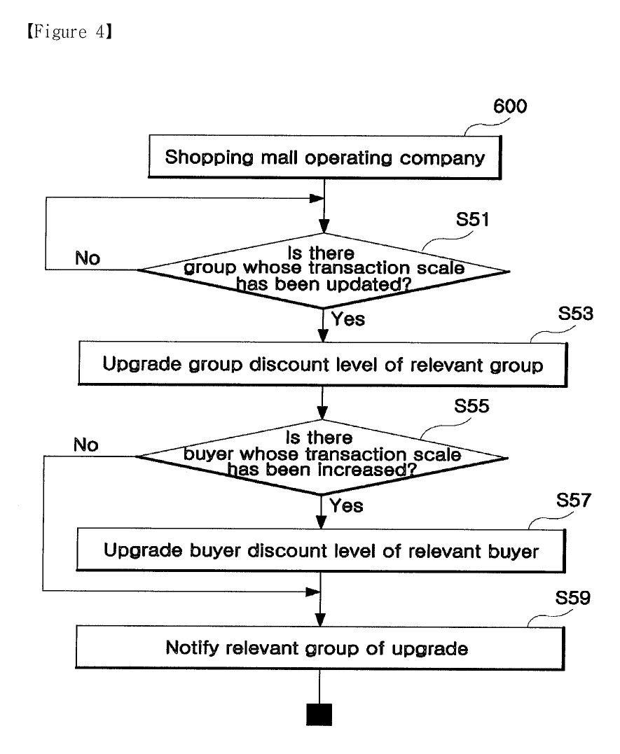

FIG. 4 is a flowchart illustrating a process of determining a discount level of a purchase broker group based on a transaction scale in a shopping mall operating method according to an embodiment of the present invention. It is noted that the subject of the determination is the management server 610 of the shopping mall operating company. However, the administrator of the shopping mall operating company 600 may directly determine the discount level.

First, in step S51, the management server searches the purchase broker group DB 645 and determines whether there is a group whose transaction scale has been updated. If it is determined that there is a group whose transaction scale has been updated, for example, in a case where a certain buyer newly joined a specific group as shown in FIG. 3 and thus a monthly transaction amoount of the group exceeds a predetermined monthly transaction amount corresponding to a group grade, a predetermined group grade is upgraded in step S53.

Next, in step S55, the management server searches the purchase broker group DB 645 and determines whether there is a buyer whose transaction scale has been increased among buyers belonging to each group. If it is determined that there is a buyer whose transaction scale has been increased, the management server updates the purchase broker group DB 645 to upgrade the buyer grade of the corresponding buyer in step S57. If it is determined that there is not a buyer whose transaction scale has been increased, the process proceeds to step S59.

In step S59, the management server notifies upgrade details to the group or buyer whose grade has been upgraded.

For reference, the administrator of the shopping mall operating company 600 or the management server 610 can change the buyer grade in the aforementioned step. However, the updated information is notified to the administrator of the corresponding group, which in turn can manually change the buyer grade through a buyer grade adjustment menu. Contrarily, if a total purchase amount of a specific group or buyer decreases rather than increases even after a predetermined period of time has passed, the discount level can be downgraded.

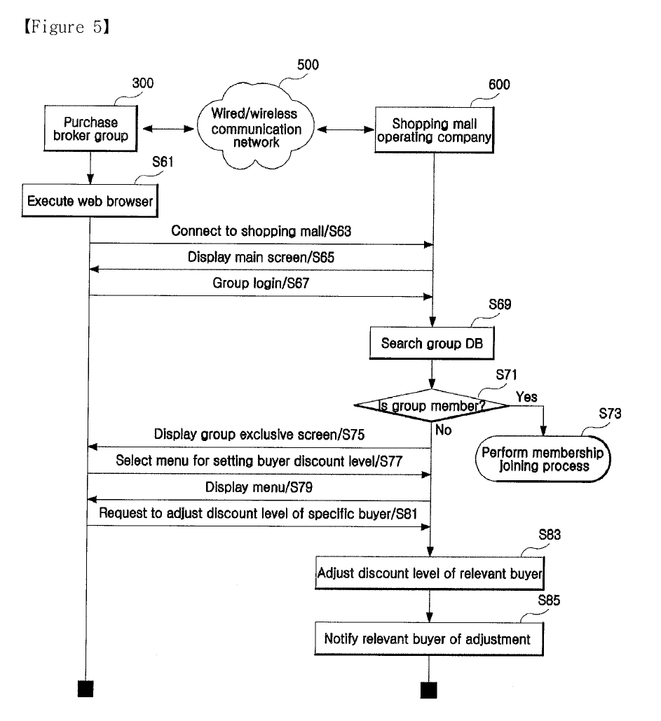

FIG. 5 is a flowchart illustrating a process of discriminatingly determining, by each purchase broker group, a discount level of a buyer (an enterprise/individual) belonging to the group based on the purchase amount of the buyer in an electronic commerce method of a group-driven purchase broker type according to an embodiment of the present invention.

First, the purchase broker group 300 executes a web browser or a WAP browser by driving a certain communication terminal in step S61 and connects to the shopping mall operating company 600 in step S63. Next, in step S65, the shopping mall server 630 displays a main screen on the communication terminal of the purchase broker group 300. In step S67, the purchase broker group 300 inputs group's identification and password into the login section dedicated to the purchase broker group 300 on the main screen displayed through the browser. In step S69, the management server 610 searches the purchase broker group DB 645 for data matching to the inputted data, i.e. the group's identification and password. In step S71, based on the searching results in step S69, the management server 610 determines whether the logged in purchase broker group 300 is an existing member. If it is determined that the group is not a member, a process of joining membership is processed by the purchase broker group 300 in step S73. At this time, the process of joining membership performed between the shopping mall operating company 600 and the purchase broker group 300 is the same as that of step S23 in theirs formats.

On the other hand, if it is determined in step S71 that the purchase broker group 300 is a member, the shopping mall server 630 displays a group exclusive screen in step S75. In step S77, the purchase broker group 300 selects a menu for setting a buyer grade provided on the group exclusive screen. In step S79, the shopping mall server 630 displays a menu window for adjusting a buyer grade of a buyer belonging to the purchase broker group 300 on the communication terminal of the purchase broker group 300.

Next, in step S81, the purchase broker group 300 selects a specific buyer among buyers belonging to the group and requests to adjust a discount level of the buyer. In step S83, the management server 610 of the shopping mall operating company 600 adjusts the discount level of the corresponding buyer, i.e. upgrades by one level. That is, the management server 610 can automatically adjust a buyer grade according to the criteria previously determined by the shopping mall operating company 600 as shown in FIG. 4. However, the buyer grade can be adjusted by the manual setting of the purchase broker group 300.

Next, in step S85, the shopping mall operating company 600 notifies the adjustment of a buyer grade to the relevant group and buyer via an e-mail, a short message service (SMS) or the like.

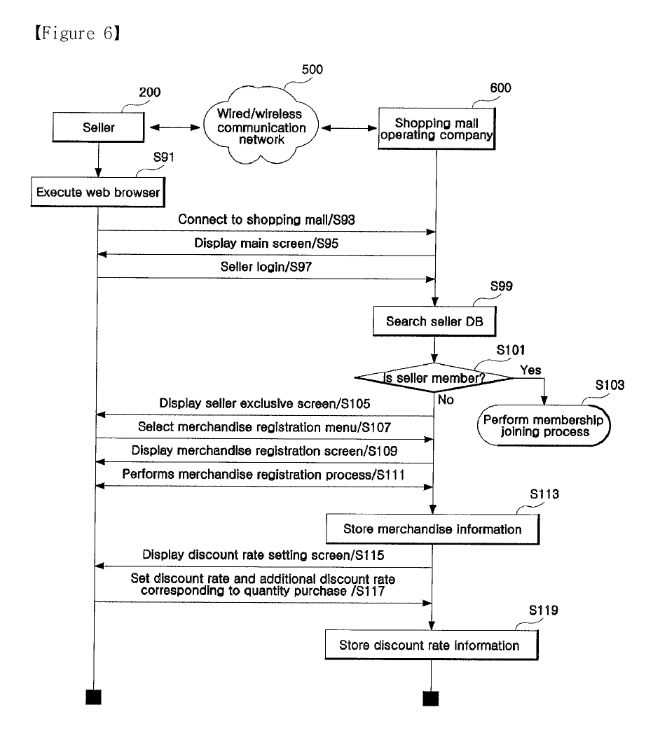

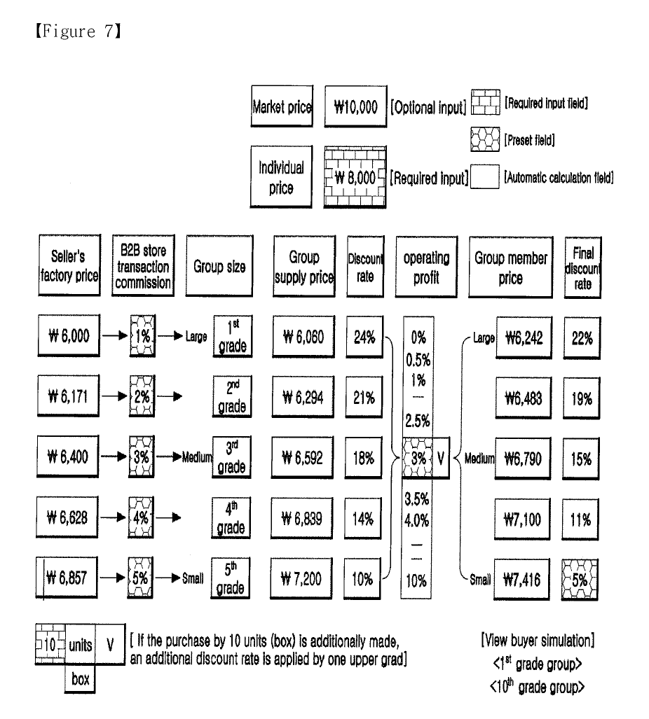

FIG. 6 is a flowchart illustrating a process of registering merchandise of a seller in an electronic commerce method of a group-driven purchase broker type according to an embodiment of the present invention, and FIGS. 7 to 9 are exemplary views illustrating a process of determining, by each seller, a discount rate in an electronic commerce method of a group-driven purchase broker type according to an embodiment of the present invention.

First, the seller 200 executes a web browser or a WAP browser by driving a certain communication terminal in step S91 and connects to the shopping mall operating company 600 in step S93. Next, in step S95, the shopping mall server 630 displays a main screen on the communication terminal of the connected seller 200. In step S97, the seller 200 inputs seller's identification and password into the login section dedicated to the seller 200 on the main screen displayed through the browser. In step S99, the management server 610 searches the seller DB 641 for data matching to the inputted data, i.e. the seller's identification and password. In step S101, based on the searching results in step S99, the management server 610 determines whether the logged in seller 200 is an existing member. If it is determined that the seller is not a member, a process of joining membership is processed by the seller 200 in step S103. At this time, the process of joining membership performed between the shopping mall operating company 600 and the seller 200 is the same as that of step S23 or S73 in their formats.

On the other hand, if it is determined in step S101 that the seller 200 is a member, the shopping mall server 630 displays a seller exclusive screen in step S105. In step S107, the seller 200 selects a merchandise registration menu provided on the seller exclusive screen. In step S109, the shopping mall server 630 displays a merchandise registration screen on the communication terminal of the seller 200.

Next, in step S111, the seller 200 performs a process of registering merchandise. If the seller 200 inputs information on a variety of merchandise, the management server 610 of the shopping mall operating company 600 stores the merchandise information into the merchandise information DB 650 in step S113.

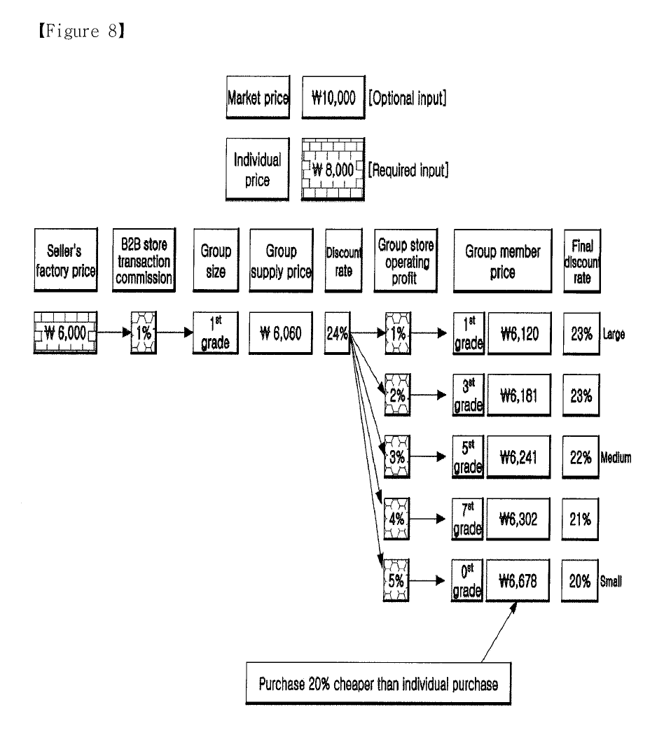

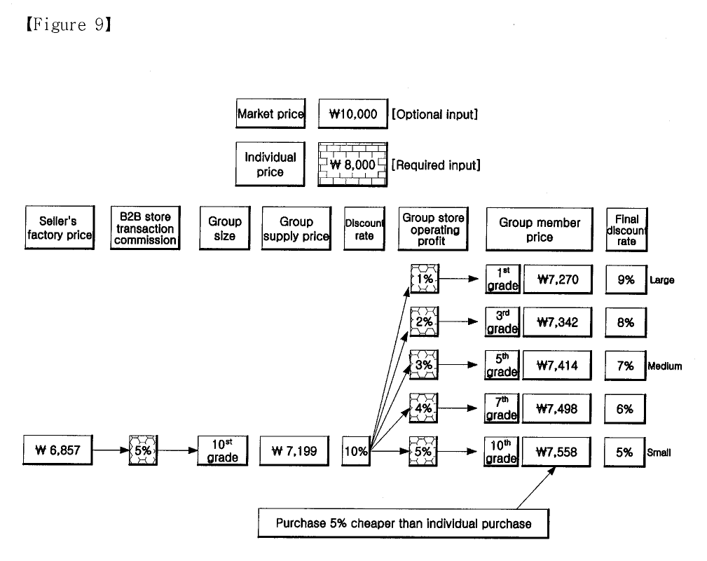

Next, the shopping mall server 630 displays a discount rate setting screen shown in FIGS. 7 to 9 on the communication terminal of the seller 200, in step S115. That is, if the seller 200 inputs through the displayed discount rate setting screen a purchase price for a non-member buyer, e.g. 8,000 Won, a supply price for a first grade group having a large buying power (6,000 Won), and a supply price for a tenth grade group having a small buying power (6,857 Won), a predetermined transaction commission for the shopping mall operating company is automatically added to the aforementioned price such that a supply price for each group grade can be automatically calculated. As shown in the figures, the supply price for the first grade group is 6,060 Won that is discounted by 24%, and the supply price for the tenth grade group is 7,200 Won that is discounted by 10%. Thus, an actual purchase price for a buyer will be a price obtained by summing up a factory price of a product, a transaction commission for the shopping mall operating company (e.g., 5%), and a brokerage commission for the group (e.g., 3%). In addition, if the seller 200 selects the first grade group and clicks the ‘to view purchase price simulation’ button shown in FIG. 7, the seller can confirm merchandise discount rates for respective buyer grades of buyers belonging to the corresponding first grade group as shown in FIG. 8. Alternatively, if the seller 200 selects the fifth grade group and clicks the ‘to view purchase price simulation’ button, the seller can confirm merchandise discount rates for respective buyer grades of the corresponding fifth grade group as shown in FIG. 9. At this time, a relevant group can apply the same purchase brokerage commission to all buyers. However, a different purchase brokerage commission can be freely applied according to the buyer grade as shown in FIG. 8 or 9, and thus, a competitive price can be secured or buyer's satisfaction can be increased.

The shopping mall operating company 600 can also apply the same transaction commission (e.g., 5%) without regard to the group grade. However, the shopping mall operating company flexibly applies a minimum transaction commission (e.g., 1%) to a group of a large transaction scale and an appropriate transaction commission (e.g., 5%) to a group of a small transaction scale according to the group grade such that a group of a large transaction scale can be supplied with merchandise at a further reduced price.

In step S117, the seller 200 inputs discount rates through the displayed discount rate setting screen and sets an additional discount rate corresponding to the quantity purchase, as shown at the lower left portion of FIG. 7. The major point of the additional discount rate is that if a buyer purchases merchandise not in ones but in bulk, the buyer can buy the merchandise at a price to which the additional discount rate is applied. For example, if a buyer whose discount level is the third grade purchases merchandise by tens, the discount level is upgraded by one level and the buyer can buy the merchandise at a price to which the second grade discount rate is applied. Further, if a buyer purchases merchandise by twenties, the discount level is upgraded by two levels and the buyer can buy the merchandise at a price to which the first grade discount rate is applied.

In step S119, the management server 610 updates the purchase broker group DB 645 such that the discount rate information inputted by the seller 200 can be stored.

Meanwhile, it has been described in step S117 that the discount rate is uniformly set according to the group grade. However, the present invention is not limited thereto, but the seller 200 can discriminatingly apply a different discount rate to a group that the seller directly selects. Accordingly, the management server 610 stores information on discount rates for individual groups in the individual discount rate DB 683.

In addition, the seller 200 can set his or her merchandise to be sold only to a particular group in a limited manner. That is, if the seller 200 set his or her merchandise to be sold at a discounted price only to the particular group, buyers 100 belonging to the relevant particular group, i.e. an enterprise or individual, can purchase the merchandise at the corresponding discounted price. Contrarily, the discounted price of the corresponding merchandise is not open to buyers 100 who do not belong to any group or belong to the other group. Even though those buyers 100 are willing to purchase the merchandise, only a regular price is open instead of the discounted price and thus the buyers will purchase the merchandise at the regular price. When using a conventional on-line shopping mall, the seller 200 has limitation in determining the prices of merchandise. However, when using the shopping mall operating company 600 of the present invention, the seller can determine different prices for different groups according to the size of a group and the prices determined by the seller 200 are not open, and thus, the conflict on price does not occur in a distribution channel.

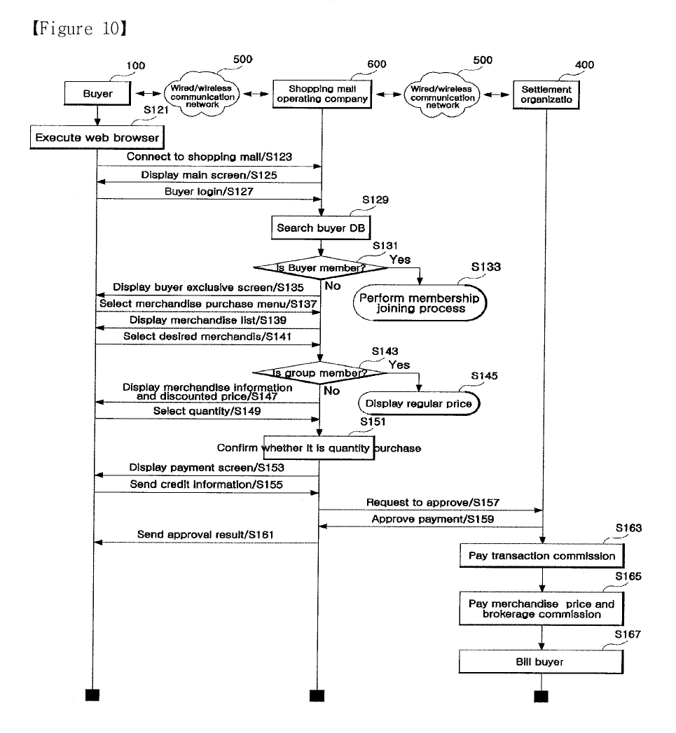

FIG. 10 is a flowchart illustrating a process of purchasing merchandise, by each buyer, in an electronic commerce method of a group-driven purchase broker type according to an embodiment of the present invention.

First, the buyer 100 executes a browser by driving a certain communication terminal in step S121 and connects to the shopping mall operating company 600 in step S123. Further, the buyer 100 can connect to the shopping mall operating company 600 by connecting to a home page of a relevant group where the buyer belongs to and then selecting a <member company joint purchase mall> menu linked to the shopping mall operating company 600 among home page menus. Next, in step S125, the shopping mall server 630 displays a main screen on the communication terminal of the connected buyer 100. In step S127, the buyer 100 inputs his or her identification and password into the login section dedicated to the buyer 100 on the main screen displayed through the browser. In step S129, the shopping mall server 630 sends data corresponding to the received buyer's identification and password to the management server 610 which in turn searches the buyer DB 641 for data matching to the inputted data, i.e. the buyer's identification and password. In step S131, based on the searching results in step S129, the management server 610 determines whether the logged in buyer 100 is an existing member. If it is determined that the buyer is not a member, a process of joining membership is processed by the buyer 100 in step S133. At this time, the process of joining membership performed between the shopping mall operating company 600 and the buyer 100 is the same as the aforementioned process of joining membership in their formats.

On the other hand, if it is determined in step S131 that the logged in buyer 100 is a member, the shopping mall server 630 displays a buyer exclusive screen in step S135. Particularly, if the buyer 100 is a buyer 100 who has previously joined a specific group, the shopping mall server 630 may display an exclusive screen of the corresponding group in step 135. The buyer 100 selects a merchandise purchase menu on the buyer exclusive screen in step S137, and the shopping mall server 630 displays a list of a variety of merchandise accordingly in step S139. The buyer 100 selects desired merchandise and transmits the information on the selected merchandise to the shopping mall server 630 in step S141.

In step S143, the management server 610 searches the group DB 645 and determines whether information on the selected merchandise is registered for a specific group and also whether the buyer 100 belongs to the specific group. If it is determined that the buyer 100 does not belong to the specific group, the shopping mall server 630 displays a regular price, i.e. a purchase price for a non-member buyer, in step S145. On the other hand, if it is determined in step S143 that the buyer 100 belongs to the specific group, the shopping mall server 630 confirms information on the relevant merchandise, the grade of the group where the buyer 100 belongs to, and the grade of the buyer 100 set by the relevant group, and then displays an appropriate discounted price in step S147.

Next, the buyer 100 selects a purchase quantity in step S149, and the management server 610 determines in step S151 whether the purchase quantity selected by the buyer 100 corresponds to a purchase quantity to which an additional discount rate can be applied. Accordingly, in step S153, the shopping mall server 630 displays a payment screen including the price of merchandise to which the merchandise discount rate was applied.

In step S155, the buyer 100 inputs his or her credit information such as a credit card number and password thereof and sends the credit information through the payment screen displayed on the browser. In step S157, the settlement server 620 requests a certain relevant settlement organization 400 to approve the payment for the purchase by sending the credit information received from the buyer 100 to the relevant settlement organization 400. The settlement organization 400 approves the payment in step S159. Accordingly, the management server 610 stores the results received from the settlement organization 400 in the receipts details DB 661, and the shopping mall server 630 sends the approval results in step S159 to the communication terminal of the buyer 100 in step S161.

The settlement organization 400 deposits a transaction commission in a bank account previously specified by the shopping mall operating company 600 in step S163, pays the price of merchandise and the brokerage commission respectively to the seller 200 and the purchase broker group 300 in step S165, and bills the buyer 100 based on the received credit information of the buyer 100 in step S167.

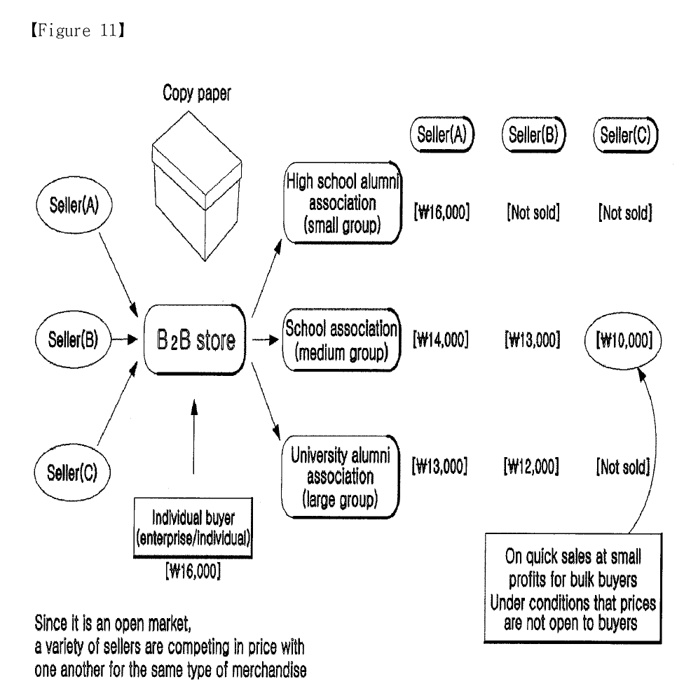

FIG. 11 is an exemplary view illustrating an example of prices discriminatingly applied for each group according to an embodiment of the present invention. As shown in FIG. 11, if seller A, seller B and seller C each selling copy paper of the same brand register the same merchandise, i.e. copy paper, and a different price for each group in the e-marketplace operated by the shopping mall operating company 600, buyers belonging to the 00 high school alumni association, 00 school association, or 00 university alumni association can buy the copy paper at a discounted price different from each other.

Although an electronic commerce system of a group-driven purchase broker type and a shopping mall operating system applied thereto according to the present invention has been described and illustrated in connection with the specific preferred embodiments, it will be readily understood by those skilled in the art that various modifications and changes can be made thereto without departing from the spirit and scope of the present invention defined by the appended claims. For example, as shown in FIG. 3, a buyer can apply for joining a group or can automatically join to a group by connecting to a home page provided by the relevant group. Further, the buyer 100 can automatically join the relevant group by inputting a group code beforehand when the buyer initially joins membership of the shopping mall operating company 600.

Further, the buyer can log in the shopping mall operating company 600 in an auto login or Single Sign On (SSO) manner through a home page of the group where the buyer belongs to.

In addition, the buyer can belong to any group, i.e. a plurality of groups, so long as the buyer meets registration requirements suggested by each group. Accordingly, the buyer can compare merchandise discount rates differently offered to each group where the buyer belongs to and select a minimum price to purchase the merchandise.

### INDUSTRIAL APPLICABILITY

According to an electronic commerce system of a group-driven purchase broker type and a shopping mall operating system applied thereto of the present invention so configured, a buyer connects to a shopping mall operating company not to individually purchase merchandise but to jointly purchases the merchandise through a purchase broker group, thereby purchasing merchandise at a price discounted from a regular price. Even though they sell merchandise at a price lower than a regular price, the sellers can easily sell merchandise to buyers belonging to cooperative groups without additionally paying for marketing expenses. Further, since buyers belonging to the cooperative group jointly purchase merchandise provided by the sellers, demands of the buyers increase accordingly, and thus, the sellers can make more profits owing to the increase of sales amount. The purchase broker group provides members with a chance to save expenses through the joint purchase and accordingly makes an income from purchase commissions, which in turn gives financial assistance in operating the group. Further, the shopping mall operating company can provide a joint purchase shopping mall to a plurality of group home pages for nothing and connect the home pages to induce the joint purchase centering on the relevant group rather than conduct direct marketing to buyers while spending a large amount of expenses. Therefore, the shopping mall operating company can get more transaction commissions owing to the increase of transaction amount.

Further, the purchase broker group brokers on-line a variety of merchandise to members at a discounted price through the shopping mall operating company, thereby improving the status of the group and promoting off-line activities of the group.

Furthermore, since the seller can apply a different discounted price to a different group according to the size or monthly purchase amount of the group when the seller registers merchandise, the purchase of merchandise provided by the relevant sellers can be further actively encouraged. In addition, when the seller needs urgent money or wishes to clear remaining stock, the seller can sell the merchandise temporarily at a greatly discounted special price for one or two specific groups in a state where the special price of the merchandise is open only to buyers belonging to the specific groups but not open to buyers who belong to other groups or do not belong to the specific groups. Therefore, the seller can sell the merchandise without conflict on price with other distribution channels.

1. An electronic commerce system of a group-driven purchase broker type, comprising:
a shopping mall operating company for providing an on-line shopping mall where a variety of merchandise is transacted and for storing discount rates of merchandise registered in the on-line shopping mall;
a sales client for registering information including prices of a variety of merchandise in the shopping mall operating company;
a group client connected to the shopping mall operating company to broker sales of merchandise at a price to which the discount rate is applied;
a purchase client belonging to the group client and connected to the shopping mall operating company to purchase merchandise through brokerage of the group client at the price to which the discount rate is applied; and
a wired/wireless communication network for connecting the shopping mall operating company, the sales client, the group client and the purchase client with one another.

2. The system as claimed in claim 1, wherein the shopping mall operating company comprises:
a shopping mall server for providing on-line shopping mall services through the wired/wireless communication network;
a member information DB for storing credit information of the sales client, purchase client and group client;
a merchandise information DB for storing information on a variety of merchandise registered in the shopping mall server by the sales client;
a discount information DB for storing discount rates to be applied to the merchandise registered by the sales client; and
a management server for sending the discount rates stored in the discount information DB to the shopping mall server based on the credit information of the group client stored in the member information DB if the purchase client connected to the shopping mall server is a purchase client belonging to the group client.

3. The system as claimed in claim 2, wherein the credit information of the group client stored in the member information DB includes information on certain merchandise among information on a variety of the merchandise stored in the merchandise information DB.

4. The system as claimed in claim 3, further comprising:
an individual discount rate DB for storing information on a discount rate applied to certain merchandise when the sales client connected to the shopping mall server registers the merchandise.

5. The system as claimed in claim 4, further comprising:
a purchase commission DB for storing information on a purchase commission to be provided to the group client.

6. The system as claimed in claim 5 wherein if the purchase client connected to the shopping mall server is a purchase client who does not belong to the group client the management server does not send the discount rate stored in the discount information DB to the shopping mall server.

7. The system as claimed in claim 6, wherein the purchase client belongs to at least two or more group clients.

8. The system as claimed in claim 2, wherein the credit information of the group client stored in the member information DB includes a transaction scale index indicating a brokerage scale of the group client and a group grade of the group client based on the transaction scale index.

9. The system as claimed in claim 8, wherein the credit information of the group client stored in the member information DB includes credit information of a purchase client belonging to the group client and a buyer grade based on the credit information.

10. The system as claimed in claim 9, wherein the discount rate stored in the discount information DB is a discount rate based on the group grade or buyer grade.

11. A shopping mall operating system, comprising:
a shopping mall server for providing on-line shopping mall services through a wired/wireless communication network;
a member information DB for storing credit information of a sales client, a purchase client, and a group client for brokering transactions of merchandise between the sales client and the purchase client, each client being connected to the shopping mall server through the wired/wireless communication network;
a merchandise information DB for storing information on a variety of merchandise registered in the shopping mall server by the sales client;
a discount information DB for storing discount rates to be applied to the merchandise registered by the sales client; and
a management server for sending the discount rates stored in the discount information DB to the shopping mall server based on the credit information of the group client stored in the member information DE if the purchase client connected to the shopping mall server is a purchase client belonging to the group client.

12. The system as claimed in claim 11, wherein the credit information of the group client stored in the member information DB includes information on certain merchandise among information on a variety of the merchandise stored in the merchandise information DB.

13. The system as claimed in claim 12, further comprising:
an individual discount rate DB for storing information on a discount rate applied to certain merchandise when the sales client connected to the shopping mall server registers the merchandise.

14. The system as claimed in claim 13, further comprising:
a purchase commission DB for storing information on a purchase commission to be provided to the group client.

15. The system as claimed in claim 14 wherein if the purchase client connected to the shopping mall server is a purchase client who does not belong to the group client the management server does not send the discount rate stored in the discount information DB to the shopping mall server.

16. The system as claimed in claim 15, wherein the purchase client belongs to at least two or mole group clients.

17. The system as claimed in claim 11, wherein the credit information of the group client stored in the member information DB includes a transaction scale index indicating a brokerage scale of the group client and a group grade of the group client based on the transaction scale index.

18. The system as claimed in claim 17, wherein the credit information of the group client stored in the member information DB includes credit information of a purchase client belonging to the group client and a buyer grade based on the credit information.

19. The system as claimed in claim 18, wherein the discount rate stored in the discount information DB is a discount rate based on the group grade or buyer grade.

20. An electronic commerce method of a group-driven purchase broker type, which is performed between a shopping mall operating company for providing an on-line shopping mall where a variety of merchandise is transacted, a sales client for registering information on a variety of merchandise in the shopping mall operating company through a wired/wireless communication network, a purchase client for purchasing a variety of merchandise from the shopping mall operating company through the wired/wireless communication network, and a plurality of group clients connected to the shopping mall operating company through the wired/wireless communication network for brokering transactions of merchandise between the sales client and the purchase client,
the method comprising the steps of:
(a) registering, by the sales client, information on merchandise in the shopping mall operating company;
(b) providing, by the shopping mall operating company, credit information of a plurality of the group clients to the sales client;
(c) selecting, by the sales client, a certain group client for brokering the merchandise registered in step (a);
(d) selecting, by the purchase client, the merchandise registered in step (a); and
(e) offering, by the shopping mall operating company, a price of merchandise, to which a predetermined discount rate is applied, to the purchase client based on the credit information of the group client selected in step (c), if the purchase client in step (d) is a purchase client belonging to the group client selected in step (c).

21. The method as claimed in claim 20, further comprising the step of:
(f) offering, by the shopping mall operating company, an additional discount rate higher than the discount rate applied in step (e) to the purchase client, if the purchase client selects more merchandise than a predetermined number in step (d).

22. The method as claimed in claim 21, wherein if the sales client selects a certain group client and applies a predetermined discount rate to merchandise to be brokered through the selected group client in step (c), the shopping mall operating company offers a price of merchandise, to which the discount rate of the sales client is applied to the purchase client in step (c).

23. The method as claimed in claim 22, further comprising the step of:
(f) if the purchase client in step (d) is a purchase client who does not belong to the group client selected in step (c), offering, by the shopping mall operating company, a price of merchandise, to which the discount rate is not applied, to the purchase client.

24. The method as claimed in claim 23, wherein the purchase client belongs to at least two or more group clients.

25. The method as claimed in claim 20, wherein the credit information of the group client includes a transaction scale index indicating a brokerage scale of the group client and a group grade of the group client based on the transaction scale index.

26. The method as claimed in claim 25, wherein the credit information of the group client includes credit information of a purchase client belonging to the group client and a buyer grade based on the credit information.

27. A shopping mall operating method, which is performed by a shopping mall operating company between the shopping mall operating company for providing an on-line shopping mall where a variety of merchandise is transacted, a sales client for registering information on a variety of merchandise in the shopping mall operating company through a wired/wireless communication network, a purchase client for purchasing a variety of merchandise from the shopping mall operating company through the wired/wireless communication network, and a plurality of group clients connected to the shopping mall operating company through the wired/wireless communication network for brokering transactions of merchandise between the sales client and the purchase client,
the method comprising the steps of:
(a) storing information on certain merchandise registered by the sale client;
(b) providing credit information of a plurality of the group clients to the sale client;
(c) selecting, by the sales client, a certain group client for brokering the merchandise registered in step (a);
(d) applying a predetermined discount rate to the registered merchandise based on the credit information of the group client selected in step (c); and
(e) offering a price of the merchandise to which the discount rate in step (d) is applied, if a purchase client belonging to the group client selected in step (c) requests to purchase merchandise.

28. The method as claimed in claim 27, further comprising the step of:
(f) offering an additional discount rate higher than the discount rate applied in step (e) to the purchase client, if the number of merchandise requested in step (e) exceeds the predetermined number of merchandise.

29. The method as claimed in claim 28, wherein if the sales client selects a certain group client and applies a predetermined discount rate to merchandise to be brokered through the selected group client in step (c), a price of merchandise to which the discount rate of the sales client is applied is offered to the purchase client in step (e).

30. The method as claimed in claim 29, further comprising the step of:
(f) if a purchase client who does not belong to the group client selected in step (c) requests to purchase merchandise, offering a price of merchandise to which the discount rate is not applied.

31. The method as claimed in claim 30, wherein the purchase client belongs to at least two or more group clients.

32. The method as claimed in claim 27, wherein the credit information of the group client includes a transaction scale index indicating a brokerage scale of the group client and a group grade of the group client based on the transaction scale index.

33. The method as claimed in claim 32, wherein the credit information of the group client includes credit information of a purchase client belonging to the group client and a buyer grade based on the credit information.

34. A computer readable recording medium on which a program for implementing the shopping mall operating method according to claim 27 is recorded.
